(19) United States
(12) Patent Application Publication
(10) Pub. No.: US 2018/0295843 A1
(43) Pub. Date: Oct. 18, 2018

(54) Gluten-Free Laminated Dough Baked Goods and Methods of Making Same

(71) Applicants: Drexel University, Philadelphia, PA (US); Brulée Bakery, LLC, Upper Darby, PA (US)

(72) Inventors: Alexandra T. ZEITZ, Southampton, PA (US); Jonathan M. DEUTSCH, Narberth, PA (US); Lila J. COLELLO, Upper Darby, PA (US)

(21) Appl. No.: 15/953,156

(22) Filed: Apr. 13, 2018

Related U.S. Application Data
(60) Provisional application No. 62/485,175, filed on Apr. 13, 2017.

(51) Int. Cl. A21D 13/04; A21D 13/16; A21D 8/04; A21D 8/06

(52) U.S. Cl. CPC A21D 13/04; A21D 8/06; A21D 8/04; A21D 13/16

(57) ABSTRACT

The invention relates, in certain aspects, to a novel baking process that allows for the production of a gluten-free laminated baked good. In certain embodiments, the baked good of the invention has a look similar or indistinguishable from that of a conventional gluten-based baked good. In other embodiments, the baked good of the invention has a taste similar or indistinguishable from that of a conventional gluten-based baked good. In yet other embodiments, the baked good of the invention has a texture similar or indistinguishable from that of a conventional gluten-based baked good.

### CROSS-REFERENCE TO RELATED APPLICATIONS

This application claims priority under 35 U.S.C. § 119(e) to U.S. Provisional Application No. 62/485,175, filed Apr. 13, 2017, which is incorporated herein by reference in its entirety.

### BACKGROUND OF THE INVENTION

Baking is a method of cooking food that uses prolonged dry heat, and is generally performed in an oven, in hot ashes, or on hot stones. Commonly baked items include biscuits (which are generally flour-based), breads (which are made by baking a dough of flour and water, and comprise bagels, bread rolls, buns, and flatbreads), brownies, cakes, cookies, crackers, and pastries.

Pastries are made from a dough of flour, water and shortening, and may be savory or sweetened. Sweetened pastries are often described as bakers' confectionery. There are five basic types of pastry: shortcrust pastry, filo pastry, choux pastry, flaky pastry and puff pastry. Pastries can be further classified as non-laminated (where fat is cut or rubbed into the flour), and laminated (when fat is repeatedly folded into the dough using a technique called lamination). In lamination, the dough is layered with butter, rolled and folded several times in succession, then rolled into a sheet. Examples of non-laminated pastries are pie crusts and brioches. Examples of laminated pastries are croissants, Danish pastries, and puff pastries. Pastries are often prepared using shortening, which is a fat food product that is solid at room temperature.

Gluten is a combination of proteins (including prolamins and glutelins) present in wheat and related grains, including barley, rye, oat, and all their species and hybrids (such as spelt, khorasan, emmer, einkorn, triticale, and so forth). Gluten has good viscoelastic properties, giving elasticity to dough, helping it rise and keep its shape. Gluten further gives the final baked product a chewy texture. Gluten, when dried and milled to a powder and added to ordinary flour dough, improves a dough's ability to rise and increases the bread's structural stability and chewiness. Thus, gluten is thought to be an essential component of baked goods, providing them with their desirable texture and shape. Further, gluten is often present in non-baked products as well, such as beer, soy sauce, ice cream and ketchup.

Unfortunately, dietary consumption of gluten is associated with a host of disorders, including celiac disease (CD), non-celiac gluten sensitivity (NCGS), wheat allergy, gluten ataxia, and dermatitis herpetiformis (DH). In particular, CD is a long term autoimmune disorder caused by a physiological reaction to gluten. CD affects primarily the small intestine of genetically predisposed subjects, and its symptoms include gastrointestinal problems such as chronic diarrhea, abdominal distention, malabsorption, loss of appetite, and among children failure to grow normally. The only effective treatment for CD is a strict lifelong gluten-free diet, which allows for recovery of the intestinal mucosa, and reduces risk of developing complications. Thus, people suffering from CD or gluten intolerance have increased the demand for gluten-free baked goods, but it is still a challenge to develop gluten-free baked products with equivalent texture and shape to the commonly available gluten-containing products.

There is thus a need in the art for novel baked goods that are gluten-free, or have lower gluten content than baked goods made with wheat and other gluten-containing grains. In certain embodiments, such baked goods should have shapes and/or textures that match closely the shapes and/or textures of gluten-containing baked goods. The present invention addresses this need.

### BRIEF SUMMARY OF THE INVENTION

The invention provides a method of producing a gluten-free laminated baked good. The invention further provides a gluten-free laminated baked good prepared according to any of the methods of the invention. The invention further provides a raw gluten-free dough.

In certain embodiments, the method comprises baking a raw gluten-free laminated dough at a temperature no greater than about 300° F., thereby providing a gluten-free laminated baked good.

In certain embodiments, the method comprises proofing a non-proofed non-retarded dough comprising milk, yeast, sugar, gluten-free flour, acetic acid aqueous solution, salt, and unsalted pliable butter. In other embodiments, the method further comprises retarding the proofed non-retarded dough. In yet other embodiments, the method further comprises turning the proofed retarded dough around a butter block, thus generating raw gluten-free laminated dough. In yet other embodiments, the method comprises proofing the raw gluten-free laminated dough. In yet other embodiments, the method comprises baking the proofed raw gluten-free laminated dough.

In certain embodiments, the raw gluten-free laminated dough is baked at a temperature ranging from about 250° F. to about 300° F. In other embodiments, the raw gluten-free laminated dough is placed in an oven at a temperature of about 300° F., at which time the oven temperature setting is reduced to about 250° F. and the dough is baked for a first time period. In certain embodiments, the first time period ranges from about 20-30 minutes. In other embodiments, the first time period ranges from about 10-30 minutes.

In certain embodiments, the gluten-free laminated baked good is punctured so as to release at least a fraction of any moisture within the baked good. In other embodiments, the punctured gluten-free laminated baked good is further baked for about 20-30 minutes at about 250° F.

In certain embodiments, the laminated baked good is at least one selected from the group consisting of a croissant, Danish pastry, puff pastry, kouign amman, cronut, turnover, bear claw, and palmier. In other embodiments, the laminated baked good is a croissant. In yet other embodiments, the laminated baked good is a Danish pastry. In yet other embodiments, the laminated baked good is a puff pastry. In yet other embodiments, the laminated baked good is a kouign amman. In yet other embodiments, the laminated baked good is a cronut. In yet other embodiments, the laminated baked good is a turnover. In yet other embodiments, the laminated baked good is a bear claw. In yet other embodiments, the laminated baked good is a palmier.

In certain embodiments, the raw gluten-free laminated dough is proofed at room temperature for 1-3 hours before baking. In other embodiments, the raw gluten-free laminated dough is prepared from a rolled laminated dough that is cut into triangle shapes that are about ¼ inch thick. In yet other embodiments, the triangle shapes are about 13 inches long and about 3.5 inches wide. In yet other embodiments, the rolled laminated dough has been subjected to 3 turns. In yet other embodiments, at least one of the turns is a letter fold turn. In yet other embodiments, each of the turns is a letter fold turn. In yet other embodiments, the rolled laminated dough is turned around a butter block. In yet other embodiments, the non-turned rolled laminated dough is retarded for about 12-15 hours at about 40° F. before being turned. In yet other embodiments, the non-retarded rolled laminated dough is proofed for about 1-3 hours at about room temperature before being retarded.

In certain embodiments, the non-proofed non-retarded dough comprises milk, yeast, sugar, gluten-free flour, acetic acid aqueous solution, salt and unsalted pliable butter. In other embodiments, the milk is selected from the group consisting of whole milk, 2% milk, 1% milk, and fat-free milk.

In certain embodiments, the (w/w) ratio for the components milk:yeast:sugar:gluten-free flour:acetic acid aqueous solution:salt:unsalted pliable butter is about (15-20):(0.5-1.5):(1.5-10) (30-35):(0.1-0.5):(0.5-1.5):(2.0-5.0), respectively, and wherein the acetic acid aqueous solution comprises about 5% (v/v) acetic acid. In yet other embodiments, the (w/w) ratio for the components milk:yeast:sugar:gluten-free flour:acetic acid aqueous solution:salt:unsalted pliable butter is about 17:1:(1.5-10):32:0.3:(1-1.5):(2.5-5.0), respectively. In yet other embodiments, the (w/w) ratio for the components milk:yeast:sugar:gluten-free flour:acetic acid aqueous solution:salt:unsalted pliable butter is about 17:1:5:32:0.3:1:2.5, respectively. In yet other embodiments, the milk is whole milk.

In certain embodiments, the firmness of the gluten-free laminated baked good is greater than about 40,000 g·sec when tested on a Chen-Hoseney Dough Stickiness Cell with a 25 mm poly(methyl methacrylate) cylinder probe (P/25P) using a 5 kg load cell. In other embodiments, the firmness ranges from about 41,000-50,000 g·sec.

In certain embodiments, the raw gluten-free dough has stickiness ranging from about 20-25 g when tested on a Chen-Hoseney Dough Stickiness Cell with a 25 mm poly(methyl methacrylate) cylinder probe (P/25P) using a 5 kg load cell. In other embodiments, the raw gluten-free dough has work of adhesion ranging from about 1.5-2.5 g·sec when tested on a Chen-Hoseney Dough Stickiness Cell with a 25 mm poly(methyl methacrylate) cylinder probe (P/25P) using a 5 kg load cell. In other embodiments, the raw gluten-free dough has dough strength ranging from about 1.8-2.5 mm when tested on a Chen-Hoseney Dough Stickiness Cell with a 25 mm poly(methyl methacrylate) cylinder probe (P/25P) using a 5 kg load cell.

### BRIEF DESCRIPTION OF DRAWINGS

The following detailed description of illustrative embodiments of the invention will be better understood when read in conjunction with the appended drawings. For the purpose of illustrating the invention, exemplary embodiments are shown in the drawings. It should be understood, however, that the invention is not limited to the precise arrangements and instrumentalities of the embodiments shown in the drawings.

FIGS. 1-3 are selected images illustrating non-limiting croissants obtained according to the protocol of Example 1. The croissants were made with a traditional croissant method substituting a gluten-free flour blend in place of traditional wheat flour.

FIG. 4 is an image illustrating a non-limiting croissant raw folded croissant obtained according to the protocol of Example 2. The croissant was made with gluten-free ingredients and using the protocol of Example 2. Note that the croissant was loosely formed to allow for expansion during proofing and baking.

FIG. 5 is an image illustrating a non-limiting baked croissant obtained according to the protocol of Example 2.

FIG. 6 is a set of bar graphs illustrating croissant texture analysis and dough texture analysis for non-limiting dough and croissant of the invention and certain comparative products. The croissant texture analysis is a measure of firmness of the finished baked good. The dough texture analysis is a measure of strength and cohesiveness of the raw dough. The second bar graph shows that the texture of the dough of the croissant prepared according to Example 2 is closer to a conventional wheat croissant than one prepared using the protocol of Example 1.

FIG. 7 is an illustrative plot obtained from measurement of dough stickiness, as described elsewhere herein.

FIG. 8 illustrates a non-limiting firmness measurement set-up of a croissant by cutting.

FIG. 9 exemplifies plots obtained for firmness measurement of pastries by cutting.

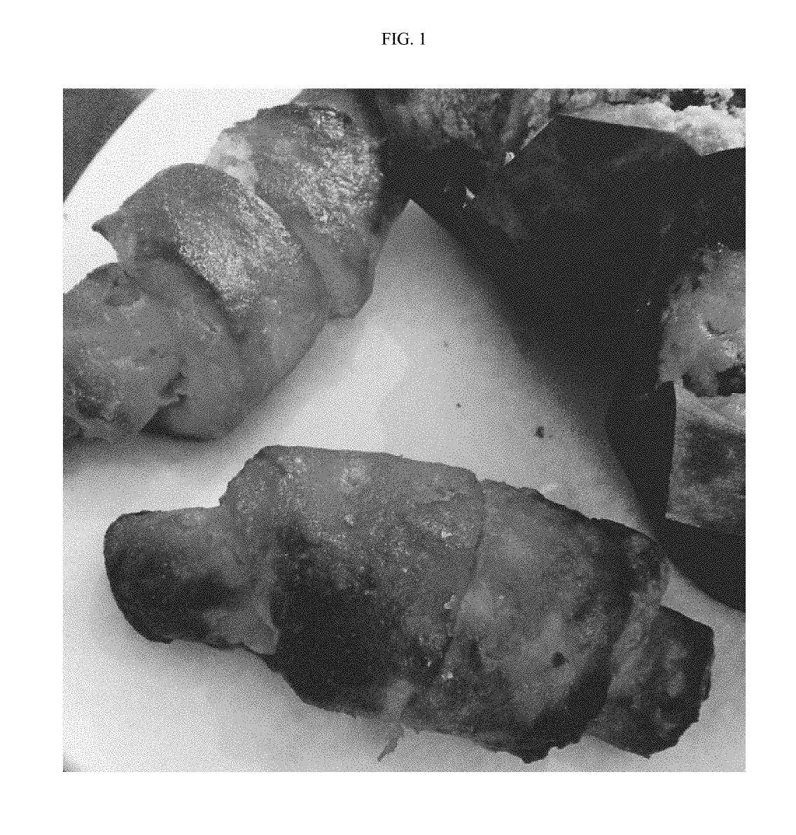

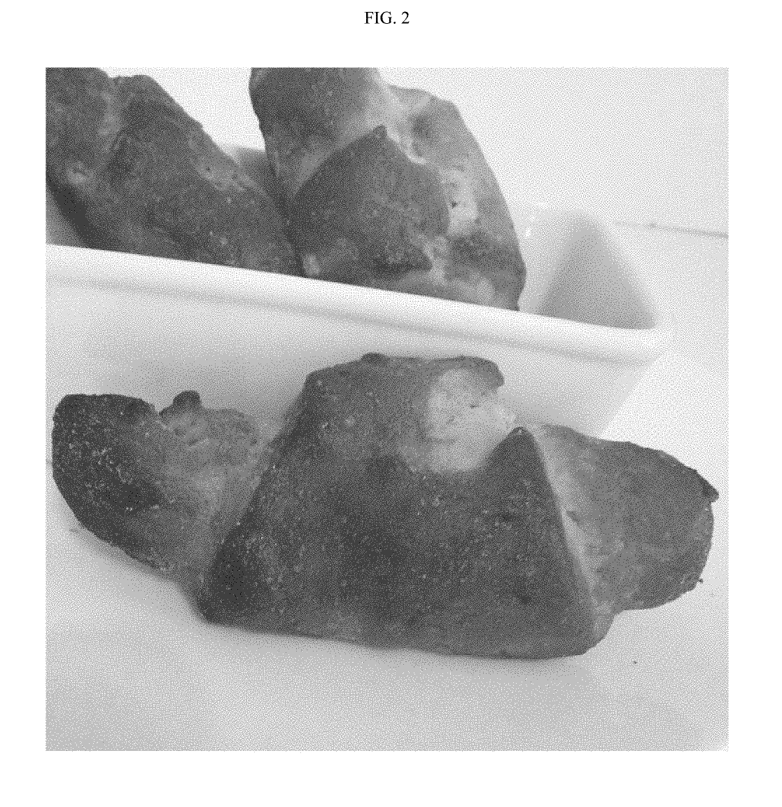

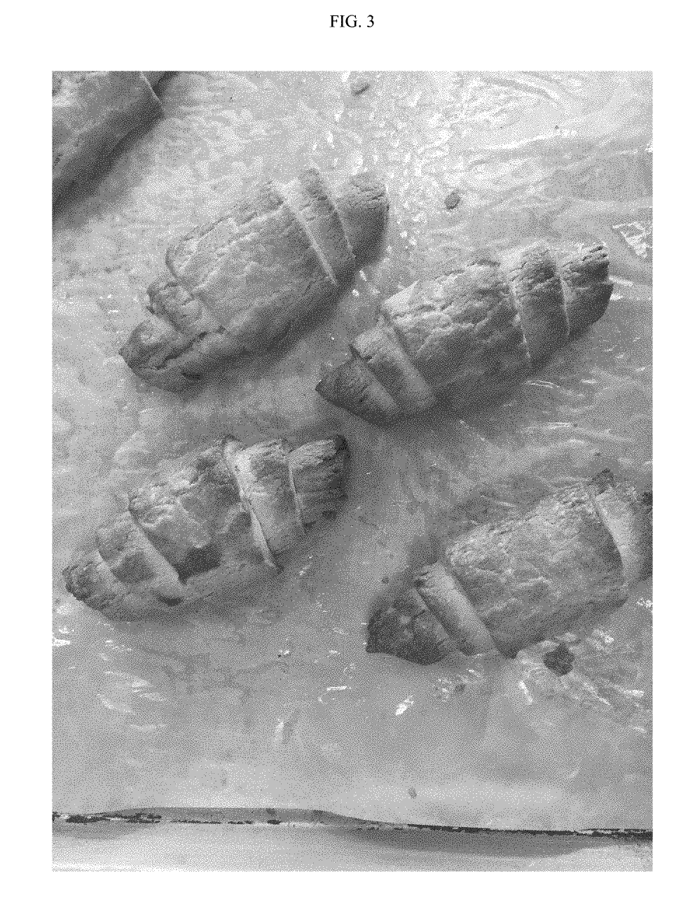

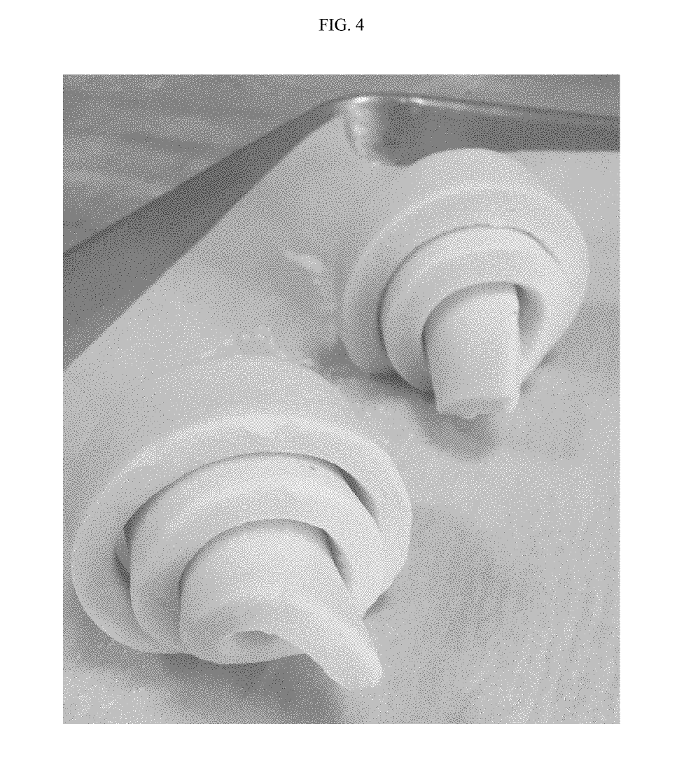

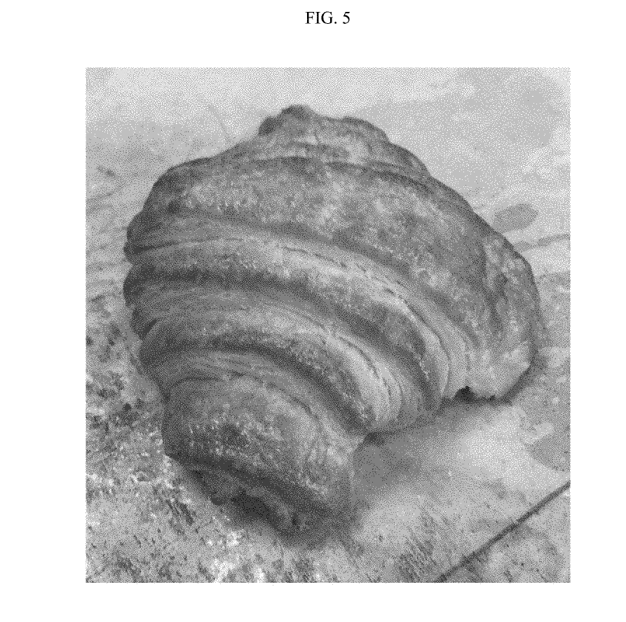

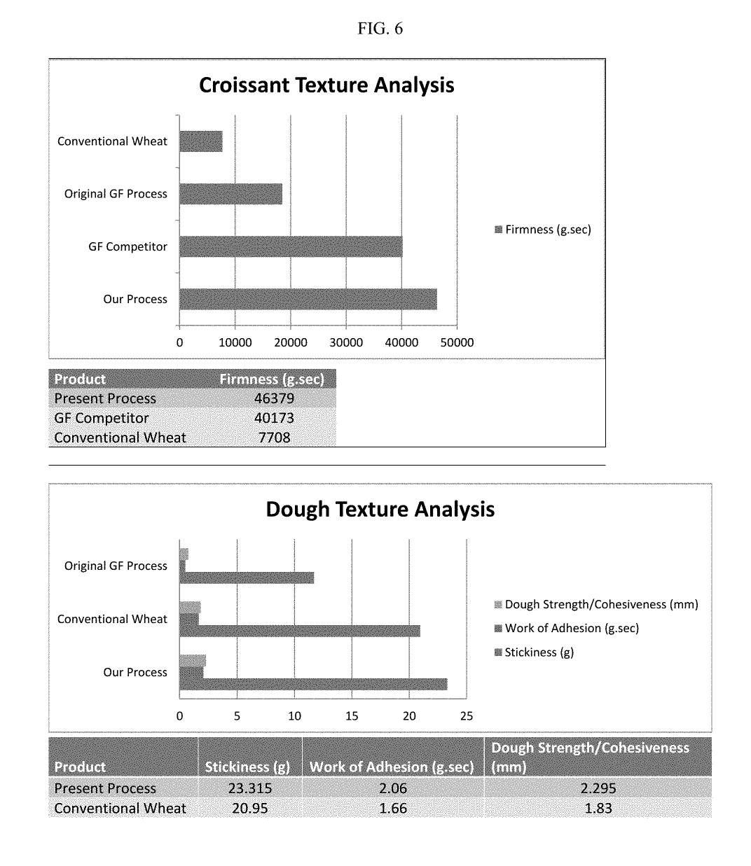

### DETAILED DESCRIPTION OF THE INVENTION

The invention relates, in certain aspects, to the discovery of a novel baking process that allows for the production of a gluten-free laminated baked good. In certain embodiments, the baked good of the invention has a look that is similar or indistinguishable from that of a conventional gluten-based baked good. In other embodiments, the baked good of the invention has a taste that is similar or indistinguishable from that of a conventional gluten-based baked good. In yet other embodiments, the baked good of the invention has a texture that is similar or indistinguishable from that of a conventional gluten-based baked good.

Traditional laminated baked goods, such as croissants, rely on gluten to allow for expansion of the dough during lamination and baking, thus providing a light and flaky texture that is characteristic of laminated baked goods. Without the presence of gluten or wheat in the baked goods, the finished products tend to be dense, with unappetizing textures and/or flavors. The laminated gluten-free baked good of the invention is light, flaky and comparable to traditional gluten-containing croissants.

### Definitions

As used herein, each of the following terms has the meaning associated with it in this section.

Unless defined otherwise, all technical and scientific terms used herein generally have the same meaning as commonly understood by one of ordinary skill in the art to which this invention belongs. Generally, the nomenclature used herein and the laboratory procedures in food chemistry and food science are those well-known and commonly employed in the art. It should be understood that the order of steps or order for performing certain actions is immaterial, so long as the present teachings remain operable. Moreover, two or more steps or actions can be conducted simultaneously or not.

As used herein, the articles “a” and “an” refer to one or to more than one (i.e., to at least one) of the grammatical object of the article. By way of example, “an element” means one element or more than one element.

As used herein, the terms “proof,” “proofing,” “proving,” or “blooming,” which can be used interchangeably herein, refer to the rise of bread dough before baking. In certain embodiments, those terms refer to a specific rest period within the more generalized process known as “fermentation,” which is a process where yeast is allowed to leaven the dough that is used to create yeast breads and baked goods.

As used herein, the term “retarding” refers to a process of slowing down the final rising in leavened bread dough. Retarding can be achieved by placing the dough in the refrigerator, which causes a slower fermentation (or rise) of the dough. In certain embodiments, retarding allows for improved favor and/or texture of the final baked good.

As used herein, the term “turn” refers to a folding sequence used with a laminating dough. There are at least two types of turns performed when laminating dough: a book turn and a letter turn. According to the book turn, one folds the wide edges inward to meet at the center, then fold the dough again over the center line, as if closing a book. According to the letter turn, one folds the dough over itself in thirds, in a similar way to folding a sheet of letter paper to fit in an envelope. The choice between book or letter folds depends on the pastry. In certain embodiments, croissants, for example, are letter-folded. In other embodiments, Danish pastries, for example, are book-folded.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 2.7, 3, 4, 5, 5.3, and 6. This applies regardless of the breadth of the range.

### DESCRIPTION

The invention relates, in certain aspects, to the discovery of a novel baking process that allows for the production of a gluten-free laminated baked good.

### Compositions

The present invention provides a gluten-free laminated baked good. In certain embodiments, the laminated baked good is at least one selected from the group consisting of a croissant, Danish pastry, puff pastry, and variations made with those doughs, including in a non-limiting manner kouign amman, cronut, turnover, bear claw, palmier, and others. In other embodiments, the laminated baked good is a croissant.

In certain embodiments, the baked good is prepared according to any of the methods described elsewhere herein. In other embodiments, the baked good has a firmness is greater than about 40,000 g·sec when cut with a knife edge (HDP/BS) using a 25 kg load cell. In yet other embodiments, the baked good has a firmness that ranges from about 41,000-50,000 g·sec when cut with a knife edge (HDP/BS) using a 25 kg load cell.

The present invention provides a raw gluten-free dough. In certain embodiments, the dough can be used to prepare at least one selected from the group consisting of a croissant, Danish pastry, puff pastry, and variations made with those doughs, including in a non-limiting manner kouign amman, cronut, turnover, bear claw, palmier, and others. In other embodiments, the dough can be used to prepare a croissant.

In certain embodiments, the dough has a stickiness ranging from about 20-25 g when tested on a Chen-Hoseney Dough Stickiness Cell with a 25 mm PERSPEX® cylinder probe (P/25P) using a 5 kg load cell. In other embodiments, the dough has a work of adhesion ranging from about 1.5-2.5 g·sec when tested on a Chen-Hoseney Dough Stickiness Cell with a 25 mm PERSPEX® cylinder probe (P/25P) using a 5 kg load cell. In yet other embodiments the dough has a dough strength ranging from about 1.8-2.5 mm when tested on a Chen-Hoseney Dough Stickiness Cell with a 25 mm PERSPEX® cylinder probe (P/25P) using a 5 kg load cell.

### Methods

The invention provides a method of producing a gluten-free laminated baked good. In certain embodiments, the method comprises baking a raw gluten-free laminated dough at a temperature no greater than about 300° F., so as to provide a gluten-free laminated baked good.

In certain embodiments, wherein the raw gluten-free laminated dough is baked at a temperature of about 250° F., about 250-260° F., about 250-270° F., about 250-280° F., about 250-290° F., or about 250-300° F.

In certain embodiments, the raw gluten-free laminated dough is placed in an oven at a temperature of about 300° F., at which time the oven temperature setting is reduced to about 250° F. and the dough is baked for a first time period. In other embodiments, the first time period ranges from about 10-20, 20-30, or 10-30 minutes.

In certain embodiments, the gluten-free laminated baked good is punctured so as to release at least a fraction of any moisture within the baked good.

In certain embodiments, the punctured gluten-free laminated baked good is further baked for about 5-15, 5-20, 20-30, or 5-30 minutes at about 250° F.

In certain embodiments, the laminated baked good is at least one selected from the group consisting of a croissant, Danish pastry, puff pastry, and variations made with those doughs, including in a non-limiting manner kouign amman, cronut, turnover, bear claw, palmier, and others. In other embodiments, the laminated baked good is a croissant.

In certain embodiments, the raw gluten-free laminated dough is proofed at room temperature (which can range from 60-74° F., for example) for about 1.5-2.5 hours, or 1-3 hours, before baking.

In certain embodiments, the raw gluten-free laminated dough is prepared from a rolled laminated dough that is cut into triangle shapes that are about ¼ inch thick.

In certain embodiments, the triangle shapes are about 13 inches long and about 3.5 inches wide. At the midpoint of the short side of the triangle, a one-inch perpendicular slit is cut.

In certain embodiments, the rolled laminated dough has been subjected to 3 turns. In other embodiments, each of the turns is a letter fold turn.

In certain embodiments, the rolled laminated dough is turned around a butter block.

In certain embodiments, the non-turned rolled laminated dough is retarded for about 12-15 hours at about 40° F. before being turned.

In certain embodiments, the non-retarded rolled laminated dough is proofed for about 1-2 hours at room temperature (such as about 60-74° F.) before being retarded.

In certain embodiments, the non-proofed non-retarded dough comprises milk. In other embodiments, the milk comprises whole milk, 2% milk, 1% milk, and/or fat-free milk. In yet other embodiments, the non-proofed non-retarded dough comprises yeast. In yet other embodiments, the non-proofed non-retarded dough comprises sugar. In yet other embodiments, the non-proofed non-retarded dough comprises gluten-free flour. In yet other embodiments, the non-proofed non-retarded dough comprises an acetic acid aqueous solution. In yet other embodiments, the non-proofed non-retarded dough comprises salt. In yet other embodiments, the non-proofed non-retarded dough comprises unsalted pliable butter.

In certain embodiments, the acetic acid aqueous solution is about 1%, 2%, 3%, 4%, 5%, 6%, 7%, 8%, 9%, 10%, 11%, 12%, 13%, 14%, 15%, 16%, 17%, 18%, 19%, or 20% (v/v) in acetic acid. In other embodiments, the acetic acid aqueous solution is about 5% (v/v) in acetic acid. In yet other embodiments, the acetic acid aqueous solution comprises at least one selected from the group consisting of white vinegar, apple cider vinegar, and lemon juice.

In certain embodiments, the (w/w) ratio for the components milk:yeast:sugar:gluten-free flour:acetic acid aqueous solution:salt:unsalted pliable butter is about (15-20):(0.5-1.5):(1.5-10):(30-35):(0.1-0.5):(0.5-1.5):(2.0-5.0), respectively.

In certain embodiments, the (w/w) ratio for the components milk:yeast:sugar:gluten-free flour:acetic acid aqueous solution:salt:unsalted pliable butter is about 17:1:(1.5-10):32:0.3:(1-1.5):(2.5-5.0), respectively.

In certain embodiments, the (w/w) ratio for the components milk:yeast:sugar:gluten-free flour:acetic acid aqueous solution:salt:unsalted pliable butter is about 17:1:5:32:0.3:1:2.5, respectively.

In certain embodiments, the (w/w) ratio for the components whole milk, yeast, sugar, gluten-free flour, aqueous acetic acid solution, salt and unsalted pliable butter is about 17:1:5:32:0.3:1:2.5, respectively.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction and preparation conditions, including but not limited to times, size/volume, and components with art-recognized alternatives and using no more than routine experimentation, are within the scope of the present application.

The following examples further illustrate aspects of the present invention. However, they are in no way a limitation of the teachings or disclosure of the present invention as set forth herein.

### Examples

The invention is now described with reference to the following Examples. These Examples are provided for the purpose of illustration only, and the invention is not limited to these Examples, but rather encompasses all variations that are evident as a result of the teachings provided herein.

### Example 1: Non-Limiting Recipe for Gluten-Free Croissant

The following ingredients were used: about 320 g gluten all-purpose gluten free flour (Brulee blend), 32 g cornstarch (or Expandex); 10 g instant yeast; 50 g sugar; 10 g salt; 52 g unsalted butter, melted and cooled; 6 fluid ounces milk, at room temperature; for butter packet: 16 tablespoons unsalted butter, chilled; egg wash (1 egg and 1 tablespoon water, beaten well) for brushing

First, the dough is prepared. In a large bowl, the flour, yeast and sugar are placed and whisked to combine well. The salt is added, and the mixture is whisked again to combine. A well is created well in the center of the dry ingredients, and the butter and milk are added. The ingredients are mixed until the dough comes together. If necessary, more flour by the half-teaspoonful is added to bring the dough together. The dough is turned out onto a lightly floured surface, and the top of the dough is sprinkled very lightly with more flour. The dough is rolled into a 9-inch round shape, wrapped tightly in plastic wrap and placed in the refrigerator to chill for 6-8 hours or overnight.

The butter packet is prepared. A piece of unbleached parchment paper is sprinkled with ⅛ cup (2 tablespoons) of the flour, and all 16 tablespoons (preferably in 2 whole sticks) of butter are placed on top and pressed together. The remaining 2 tablespoons of flour are sprinkled on the butter, and the butter is covered with another piece of unbleached parchment paper. The butter is pounded with a rolling pin, until it flattens and melds together. The flattened butter is uncovered and folded in half, covered again with the parchment paper, and pounded again to a 5-inch square butler packet. The butter packet is completely covered with parchment paper, and placed in the refrigerator to chill for 5 minutes or until firm.

The butter packet is then wrapped in the dough. The 9-inch round dough is removed from the refrigerator, unwrapped, and placed on a lightly floured surface. The chilled butter packet is placed directly in the center of the dough, and the sides of the dough are scored lightly to represent the exact size of the butter. The butter is removed and set aside. With a rolling pin (the dough is sprinkled lightly with flour as necessary to prevent it from sticking), one begins at the site of each of the four scorings and rolls the edges of the dough away from the center to create four flaps, leaving the center of the dough intact. The butter packet is returned to the intact center of the dough, and the flaps of the dough are wrapped around the butter packet (in a matter similar to gift wrapping).

The dough is rolled out with the butter and the first turn is completed. The dough-and-butter-packet is lightly sprinkled with more flour, and rolled out into a ½-inch thick rectangle. The rectangle is folded over on itself in thirds (letter turning). The dough is sprinkled again lightly with flour. With the length of the 3-layer rectangle of dough running parallel to one's body, one rolls the dough away from herself into a rectangle that is about ½-inch thick. The left and right sides of the ½-inch thick rectangle are turned over on themselves again (letter turning). Once this first turn is completed, the folded dough is wrapped tightly in plastic wrap and placed in the refrigerator to chill for at least 4 hours or up to overnight.

Remaining turns are performed. Once the dough has finished chilling after its first turn, the process of rolling the 3-layer dough out into a ½-inch thick rectangle is repeated, followed by refolding the dough like a business letter between 4-5 times. The 3-layer rectangle of dough is wrapped and chilled in the refrigerator for at least 30 minutes in between turns.

The croissants are shaped and proofed. Rimmed baking sheets are lined with unbleached parchment paper and set aside. The prepared 3-layer croissant dough is rolled out into a ¼-inch thick rectangle. Using a pastry wheel or pizza wheel (or sharp knife), the edges are squared, then as many 4-inch×6-inch rectangles as possible are cut out. Each rectangle is sliced diagonally into two triangles, and the shapes are separated from one another. The material is sprinkled lightly with flour as necessary to prevent sticking, and each triangle is rolled out to about 6-inches from base to tip. A notch is sliced into the base of each triangle about ½-inch deep, and each triangle is rolled into a coil from base to tip; the edges are turned slightly away from each other as the triangle is being rolled. The product is placed on the prepared baking sheets, seam side down, about 2-inches apart from one another. The product is covered lightly with oiled plastic wrap and placed in a warm, draft-free location until nearly doubled in size. In certain embodiments, the individual layers in each fold begin to separate slightly from one another once the croissants are fully proofed. The baking sheets are covered, and the tops and sides of the croissants are brushed with the egg wash. To avoid gluing the coiled layers of each croissant together, each croissant is brushed with the egg wash from the center of each pastry to the sides, in one motion on each side, along the “grain” of each coil. The shaped and proofed croissants was placed in the refrigerator to chill for at least 10 minutes or until mostly firm.

The croissants are baked. While the shaped croissants are chilling, the oven is preheated to 400° F. The chilled and proofed croissants are placed in the center of the preheated oven, one baking sheet at a time, and baked for about 15 minutes, or until deep golden brown all over and firm to the touch. The croissants can be allowed to cool briefly before serving.

### Example 2: Non-Limiting Recipe for Gluten-Free Croissant

The following ingredients were used: 170 g whole milk; 10 g yeast; 50 g sugar; 320 g gluten-free flour; 3 g of an aqueous solution comprising about 5% (v/v) acetic acid (which may be, for example, white vinegar, apple cider vinegar, and/or lemon juice); 10 g salt; 25 g pliable butter; 250 g butter (for preparing butter block; this amount can be varied from about 200 g to about 300 g).

In a large bowl, the milk, yeast, the acidic solution, and sugar are mixed together (preferably using a mixer) to form a first mixture, and allowed to rest for 10 minutes. In another large bowl, the flour, and salt are mixed together (preferably using a mixer) to form a second mixture. Then, the second mixture is added to the first mixture, and the system is mixed for about 5 minutes (preferably using a mixer) until a homogenous mixture is formed. Under constant mixing, the pliable butter is added to the homogenous mixture, one piece at a time, until it is fully incorporated. The dough is allowed to proof for about 2 hours at room temperature, and then retarded overnight. The dough is then removed from the refrigerator and brought to room temperature.

A butter block is prepared by pounding 250 g butter into a 13×9 inch rectangle. On a gluten-free floured board, the dough is rolled to a dimension of about 13×18 inch. The butter block is placed in the center of the dough, and folded into a letter fold. The dough is laminated with a first turn: the dough is turned horizontally and rolled to about 13×18 inch; the edges are trimmed; the dough is placed on a sheet tray and refrigerated for about 15 minutes. The process is then repeated two more times to afford two more turns.

The dough is rolled so it is about 15 inches in height and about ¼-inch thick. Croissant triangles measuring 13 inches long and 3.5 inches wide are cut, and weighted to about 130 g. The croissants are rolled very loosely, with space among the folds, and then placed on a prepared sheet tray.

The unbaked croissants are proofed at room temperature for 2 hours, and then egg washed gently. An oven is preheated to 300° F., and the setting is then lowered to 250° F. at the time of baking. The croissants are baked at about 250° F. for about 20 minutes. The croissants are removed from the oven. With a paring knife, a hole is poked in the bottom of the croissants to allow the moisture to be released. The croissants are transferred to a wire rack, baked for another 20-30 minutes at 250° F., and then allowed to cool.

### Example 3: Measurement of Dough Stickiness

TABLE 1
TA Settings

| Option: | Adhesive Test | |
|---|---|---|
| Pre-Test Speed: | 0.5 | mm/s |
| Test Speed: | 0.5 | mm/s |
| Post-Test Speed: | 10.0 | mm/s |
| Distance: | 4 | mm |
| Force: | 40 | g |
| Time: | 0.1 | s |
| Trigger Type: | Auto - 5 g | |
| Tare Mode: | Auto | |
| Data Acquisition Rate: | 500 | pps |

Accessory: 25 mm PERSPEX® cylinder probe (P/25P) using 5 kg load cell; SMS/Chen-Hoseney Dough Stickiness Cell (A/DSC)

### Test Set-Up:

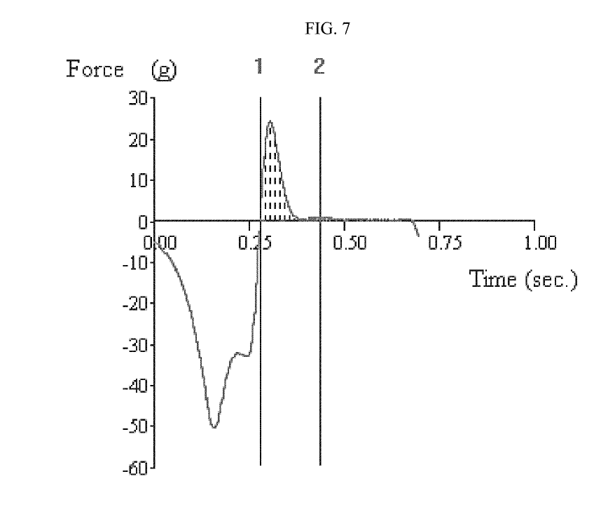

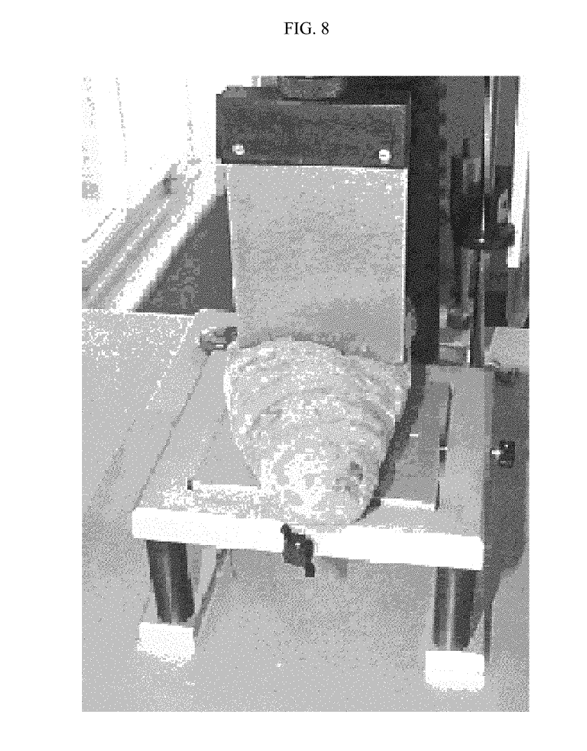

Before using the cell, the internal screw is rotated to move the piston and the sample chamber is increased to its maximum capacity. A small quantity of prepared dough is place into the chamber, and the excess dough is removed with a spatula, so that it is flush with the top of the chamber. The extruder lid is screwed on, and the internal screw is rotated a little way to extrude a small amount of dough through the holes. This first extrusion is removed from the lid surface using a spatula. The screw is rotated once again to extrude a 1 mm high dough sample. The poly(methyl methacrylate) (PERSPEX®) cap is placed over the exposed sample surface to minimize moisture loss, whilst allowing the prepared dough surface to rest for 30 seconds to release the stress produced by extrusion (if moisture loss appears to be a problem, whilst waiting for the dough to relax, a moist piece of filter paper is place under the PERSPEX® cap). After this time the cover is removed, and the cell is placed directly under the 25 mm cylinder probe attached to the load cell. The adhesive test is commenced. The dough can then be removed from the lid surface and extruded again to repeat the test, using the above procedure. A typical plot is exemplified in FIG. 7.

### Observations:

The negative region of the plot when the test commences is a result of 40 g of force being applied for 0.1 s to compress the sample slightly. The positive region of the plot however is of overall importance. The maximum force reading, i.e., highest positive peak, the positive area and the distance between the anchors set (“travel”) are all indicators of the stickiness or rheological properties of the dough.

### Data Analysis:

Once tests have been performed, values of particular interest for sample analysis can be automatically obtained by a MACRO, e.g., Table 2.

TABLE 2

| | | |
|---|---|---|
| Clear Graph Results | | |
| Redraw | | |
| Search Forwards | | |
| Go to Min. Time | | |
| Go to | Force | 0 g |
| Drop Anchor | 1 | |
| Go to Abs. +ve Value | Force | |
| Mark Value | Force | |
| Go to | Force | 1 g |
| Drop Anchor | 2 | |
| Area | | |
| Travel | | |

This macro is a general example for the analysis of a curve such as the one above. Any changes made to the test parameters or significant differences to the shape of the curve profile may require optimization of this macro. The macro may also include analytical features that are not present in all versions of Stable Micro Systems software.

When extruding the sample ensure that at least 1 mm of dough is extruded to avoid base effect contribution, which will cause erroneous results.

The operator must ensure that, when the lid is screwed onto the cell, dough contained in the chamber does not come into contact with the lid, so as to prevent the dough from twisting during lid placement, therefore eliminating a torsional stress.

If a long contact time is required before probe withdrawal, it may be preferable to use the delay acquisition feature in the software rather than compromise by reducing the data acquisition rate. When the delay acquisition feature is used the probe: product contact part of the test is performed by the Texture Analyser, but data will not be collected. Data is captured only upon probe withdrawal i.e. the important section of the graph required for data analysis.

An applied force of 40 g has been selected, in this instance, as this value was considered most suitable to achieve full contact between the sample and the probe surface. If one was to consider testing samples of much firmer consistency, then it may be necessary to increase the force value if full contact is not achieved. This will also be true if one chooses to use a cylinder of larger diameter.

The test may be modified to contact the sample with a greater force or for a longer probe contact duration. This subsequently increases both the Stickiness and Work of Adhesion values. Any values obtained are only relative at the specified contact force and time for which they are tested. The speed of probe: dough separation (i.e., the Post-Test Speed) also greatly affects the magnitude of the adhesive parameters. Any comparisons made between test results can only be based on the same testing conditions.

When attempting to optimize test settings, it is suggested that the first tests are performed on the hardest samples to anticipate the maximum testing range required and ensure that the force capacity allows testing of all future samples.

### Example 4: Firmness Measurement of Croissants by Cutting

TABLE 3
TA Settings:

| Mode: | Measure Force in Compression | |
|---|---|---|
| Option: | Return To Start | |
| Pre-Test Speed: | N/A | |
| Test Speed: | 2.0 | mm/s |
| Post-Test Speed: | 10.0 | mm/s |
| Distance: | 55 mm (probe calibrated to 60 mm) | |
| Trigger Type: | Button | |
| Tare Mode: | Auto | |
| Data Acquisition Rate: | 250 | pps |

Accessory: Knife Edge (HDP/PS) using 25 g load cell; Heavy Duty Platform (HDP/90)

### Test Set-Up:

A blank plate is secured in the Heavy Duty Platform. The Knife Edge is attached to the load cell carrier and lowered toward the platform surface. The blade is calibrated to acknowledge the platform surface as a zero distance by clicking on:

### T.A.: Calibrate Probe: 60 mm (Selected Blade Return Distance).

The blade should then be raised to allow placement of the sample.

### Sample Preparation:

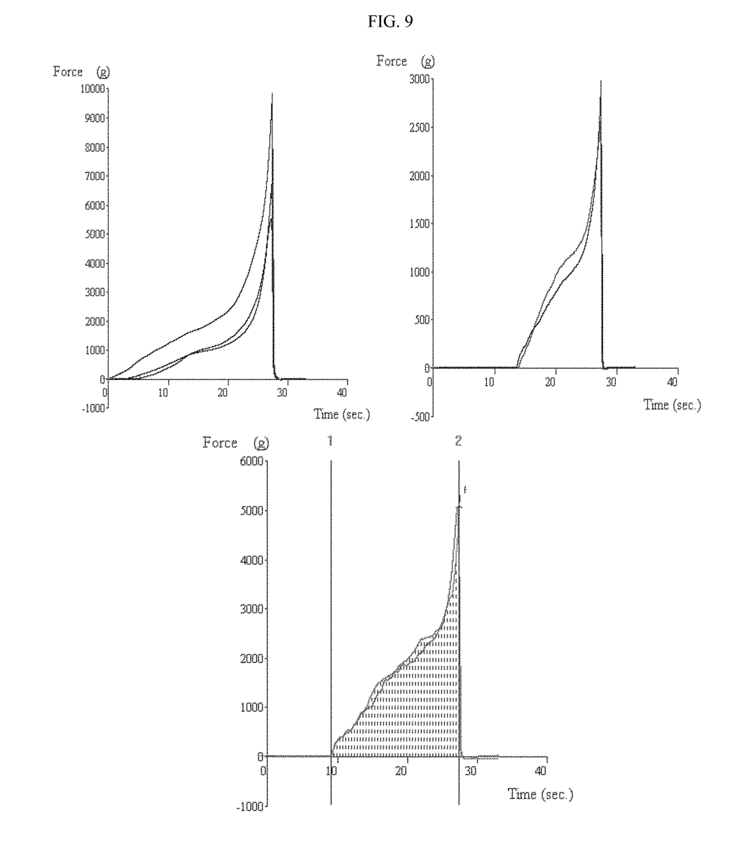

Samples are removed from their packets just prior to testing, and each is then placed centrally under the Knife Edge. Typical plots from croissants tested at 20° C. are provided in FIG. 9.

### Observations:

As the blade moves down into the sample, the force is seen to increase. The higher the force value, the firmer is the sample. Firmness is the property that changes with duration of shelf life, i.e., fresh samples normally require less force to cut in comparison to the same sample type produced on a previous date. The area under the curve is a measure of the total amount of work involved in performing the test. A higher area value indicates that a sample is much firmer.

### Data Analysis:

Once tests have been performed, values of particular interest for sample analysis can be automatically obtained by a MACRO, e.g., Table 4:

TABLE 4

| | |
|---|---|
| Clear Graph Results | |
| Redraw | |
| Search Forwards | |
| Go to Min. Time | |
| Drop Anchor | |
| Go to Abs. +ve Value | Force |
| Drop Anchor | |
| Area | |

This macro is a general example for the analysis of a curve such as the one above. Any changes made to the test parameters or significant differences to the shape of the curve profile may require optimization of this macro.

When attempting to optimize test settings, it is suggested that the first tests be performed on the hardest samples, so as to anticipate the maximum testing range required and ensure that the force capacity allows testing of all future samples.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of producing a gluten-free laminated baked good, the method comprising baking a raw gluten-free laminated dough at a temperature no greater than about 300° F., thereby providing a gluten-free laminated baked good.

2. The method of claim 1, wherein the raw gluten-free laminated dough is baked at a temperature ranging from about 250° F. to about 300° F.

3. The method of claim 2, wherein the raw gluten-free laminated dough is placed in an oven at a temperature of about 300° F., at which time the oven temperature setting is reduced to about 250° F. and the dough is baked for a first time period.

4. The method of claim 3, wherein the first time period ranges from about 20-30 minutes.

5. The method of claim 1, wherein the gluten-free laminated baked good is punctured so as to release at least a fraction of any moisture within the baked good.

6. The method of claim 1, wherein the punctured gluten-free laminated baked good is further baked for about 20-30 minutes at about 250° F.

7. The method of claim 1, wherein the laminated baked good is at least one selected from the group consisting of a croissant, Danish pastry, puff pastry, kouign amman, cronut, turnover, bear claw, and palmier.

8. The method of claim 7, wherein the raw gluten-free laminated dough is proofed at room temperature for 1-3 hours before baking.

9. The method of claim 8, wherein the raw gluten-free laminated dough is prepared from a rolled laminated dough that is cut into triangle shapes that are about ¼ inch thick.

10. The method of claim 9, wherein the triangle shapes are about 13 inches long and about 3.5 inches wide.

11. The method of claim 10, wherein the rolled laminated dough has been subjected to 3 turns.

12. The method of claim 11, wherein the rolled laminated dough is turned around a butter block.

13. The method of claim 12, wherein the non-turned rolled laminated dough is retarded for about 12-15 hours at about 40° F. before being turned.

14. The method of claim 12, wherein the non-retarded rolled laminated dough is proofed for about 1-3 hours at about room temperature before being retarded.

15. The method of claim 14, wherein the non-proofed non-retarded dough comprises milk, yeast, sugar, gluten-free flour, acetic acid aqueous solution, salt and unsalted pliable butter.

16. The method of claim 15, wherein the (w/w) ratio for the components milk:yeast:sugar:gluten-free flour:acetic acid aqueous solution:salt:unsalted pliable butter is about (15-20):(0.5-1.5):(1.5-10) (30-35):(0.1-0.5):(0.5-1.5):(2.0-5.0), respectively, and wherein the acetic acid aqueous solution comprises about 5% (v/v) acetic acid.

17. The method of claim 16, wherein the (w/w) ratio for the components milk:yeast:sugar:gluten-free flour:acetic acid aqueous solution:salt:unsalted pliable butter is about 17:1:(1.5-10):32:0.3:(1-1.5):(2.5-5.0), respectively.

18. The method of claim 17, wherein the (w/w) ratio for the components milk:yeast:sugar:gluten-free flour:acetic acid aqueous solution:salt:unsalted pliable butter is about 17:1:5:32:0.3:1:2.5, respectively.

19. A method of producing a gluten-free laminated baked good, wherein the method comprises proofing a non-proofed non-retarded dough comprising milk, yeast, sugar, gluten-free flour, acetic acid aqueous solution, salt, and unsalted pliable butter.

20. The method of claim 19, wherein the (w/w) ratio for the components milk:yeast:sugar:gluten-free flour:acetic acid aqueous solution:salt:unsalted pliable butter is about (15-20):(0.5-1.5):(1.5-10) (30-35):(0.1-0.5):(0.5-1.5):(2.0-5.0), respectively, and wherein the acetic acid aqueous solution comprises about 5% (v/v) acetic acid.

21. The method of claim 20, wherein the (w/w) ratio for the components milk:yeast:sugar:gluten-free flour:acetic acid aqueous solution:salt:unsalted pliable butter is about 17:1:(1.5-10):32:0.3:(1-1.5):(2.5-5.0), respectively.

22. The method of claim 21, wherein the (w/w) ratio for the components milk:yeast:sugar:gluten-free flour:acetic acid aqueous solution:salt:unsalted pliable butter is about 17:1:5:32:0.3:1:2.5, respectively.

23. A gluten-free laminated baked good, which firmness is greater than about 40,000 g·sec when tested on a Chen-Hoseney Dough Stickiness Cell with a 25 mm poly(methyl methacrylate) cylinder probe (P/25P) using a 5 kg load cell.

24. The baked good of claim 23, which firmness ranges from about 41,000-50,000 g·sec.

25. A raw gluten-free dough, with at least one of the following characteristics when tested on a Chen-Hoseney Dough Stickiness Cell with a 25 mm poly(methyl methacrylate) cylinder probe (P/25P) using a 5 kg load cell:
(a) stickiness ranging from about 20-25 g;
(b) work of adhesion ranging from about 1.5-2.5 g·sec; and
(c) dough strength ranging from about 1.8-2.5 mm.

26. A gluten-free laminated baked good prepared according to the method of claim 1.

27. A gluten-free laminated baked good prepared according to the method of claim 19.
